(19) United States
(12) Patent Application Publication
(10) Pub. No.: US 2024/0370058 A1
(43) Pub. Date: Nov. 7, 2024

(54) Segmented Glass for Foldable Devices

(71) Applicant: Apple Inc., Cupertino, CA (US)

(72) Inventors: Christopher D. Jones, Los Gatos, CA (US); Que Anh S. Nguyen, San Jose, CA (US); Matthew S. Rogers, San Jose, CA (US); Christopher C. Bartlow, Menlo Park, CA (US)

(21) Appl. No.: 18/596,261

(22) Filed: Mar. 5, 2024

Related U.S. Application Data
(60) Provisional application No. 63/499,932, filed on May 3, 2023.

(51) Int. Cl. G06F 1/16; G09F 9/30

(52) U.S. Cl. CPC G06F 1/1652; G09F 9/301

(57) ABSTRACT

An electronic device may have a display and may be configured to fold about a bend axis that overlaps the display. The display may have a display cover layer having first, second, and third portions that are joined side-by-side. The second portion may have a strip shape that extends along the bend axis and may be configured to bend as the first and third portions are folded towards each other. The second portion may be formed from a different material than the first and third portions to facilitate bending. The second portion may also be characterized by a compressive stress layer that is shallower than compressive stress layers on the first and third portions.

This application claims the benefit of provisional patent application No. 63/499,932, filed May 3, 2023, which is hereby incorporated by reference herein in its entirety.

### FIELD

This relates generally to electronic devices, and, more particularly, to glass for foldable electronic devices.

### BACKGROUND

Electronic devices may have displays. An electronic device display may be used to present information for a user. In some devices, displays may be covered with protective cover glass.

### SUMMARY

An electronic device may have a display and may be configured to fold about a bend axis that overlaps the display. The display may have a display cover layer with first, second, and third portions that are joined side-by-side and extend laterally across the display. The second portion may have a strip shape that extends along the bend axis and that is configured to bend as the first and third portions are folded towards each other.

The second portion may be formed from a different material than the first and third portions to facilitate bending. For example, the second portion may be formed from a glass with a lower modulus of elasticity than the first and third portions. The second portion may also be thinner than the first and third portions and may be characterized by a compressive surface stress layer that is shallower than compressive surface stress layers in the first and third portions.

### BRIEF DESCRIPTION OF THE DRAWINGS

FIG. 1 is a side view of an illustrative electronic device with a display in a partly folded configuration in accordance with an embodiment.

FIG. 2 is a top view an illustrative display cover layer in an unfolded configuration in accordance with an embodiment.

FIGS. 3 and 4 are cross-sectional side views of illustrative display cover layers showing how a strip-shaped central portion of a display cover layer may be formed from a different material than laterally adjacent left and right side portions of the display cover layer in accordance with embodiments.

FIG. 5 is a cross-sectional side view of an illustrative display cover layer showing how the layer may be chemically strengthened in accordance with an embodiment.

### DETAILED DESCRIPTION

Electronic devices may be provided with displays. Displays may be used for displaying images for users. Displays may be formed from arrays of light-emitting diode pixels or other pixels. For example, a device may have a flexible organic light-emitting diode display or a flexible display formed from an array of micro-light-emitting diodes (e.g., diodes formed from crystalline semiconductor dies). Electronic devices with flexible displays may be provided with hinges so that the devices can be folded for storage.

FIG. 1 is a side view of an illustrative folding electronic device in a partly folded configuration. Device 10 of FIG. 1 may be a portable device such as a cellular telephone, tablet computer, or laptop computer, or may be any other suitable electronic device with a display.

Device 10 may include control circuitry. The control circuitry may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in the control circuitry may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, the control circuitry of device 10 may use a display and other output devices in providing a user with visual output and other output.

Display 14 of device 10 may have an array of pixels such as pixel array 22 (sometimes referred to as a display or display layer) that is configured to display images for a user. The pixels may be formed as part of a display panel that is bendable. This allows device 10 to be folded and unfolded about a bend axis. For example, a flexible (bendable) display in device 10 may be folded so that device 10 may be placed in a compact shape for storage and may be unfolded when it is desired to view images on the display. Pixel array (display) 22 may be covered by a transparent protective layer such as display cover layer 20. Display cover layer 20 may be formed from glass, glass-ceramic, transparent ceramic, transparent crystalline materials such as sapphire, or other transparent protective material.

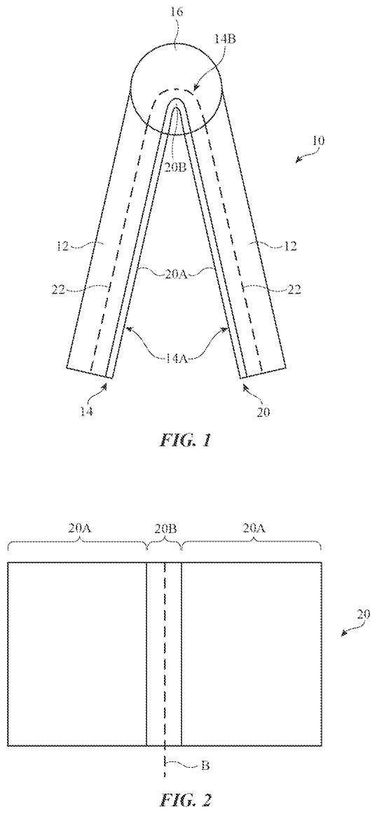

As shown in FIG. 1, device 10 may have a housing such as housing 12 in which display 14 is mounted. Hinge 16 may be used to attach first and second portions of housing 12 together. Hinge 16 allows the first and second portions (left and right sides) of housing 12 to rotate with respect to each other about a hinge axis (sometimes referred to as a fold axis or bend axis). Display 14 may have planar portions such as portions 14A and a bendable portion such as bendable portion 14B that is located between the planar portions. When device 10 is in an unfolded (planar) configuration, portion 14B is unbent (planar). When the left and right sides of device 10 are folded together as shown in FIG. 1, portion 14B bends. To prevent display cover layer 20 from becoming damaged (e.g., cracking) when device 10 is folded, display cover layer 20 may have a strip-shaped bendable portion such as portion 20B that overlaps hinge 16 and extends along its associated bend axis (see, e.g., bend axis B of FIG. 2, which shows a top view of layer 20). The width of portion 20B orthogonal to bend axis B may be 20 mm, 10-30 mm, 1-50 mm, at least 0.5 mm, less than 60 mm, or other suitable width.

Because portion 20B of layer 20 must bend during folding and unfolding operations as portions 20A are folded towards each other and unfolded away from each other, it is desirable for portion 20B to be highly flexible. Planar portions 20A of display cover layer 20 may be supported by planar portions of housing 12 and need not be as flexible as bendable portion 20B. Accordingly, it may be desirable to form portions 20A and 20B of layer 20 using different materials (e.g., different glasses), so that portion 20B is more flexible than portion 20A, using different chemical strengthening treatments (e.g., so that portions 20A are characterized by deeper compressive surface stress than portion 20B), different thicknesses (e.g., so that portion 20B is thinner and therefore more flexible than portion 20A) and/or using other materials, shapes, and processing treatments that allow portion 20B to flex while providing portions 20A with desirable properties such as strong resistance to damage from exposure to contact with sharp objects.

As an example, portions 20A and 20B may be formed from different types of glass having different respective elasticities. The glass used to form portion 20B may have a modulus of elasticity that is lower than the glass forming portions 20A to allow portion 20B to bend. Portions 20A and 20B, which laterally extend across the surface of pixel array 22 and display 14, may be joined in a side-to-side fashion by fusing different pieces of sheet glass together or by forming portions 20A and 20B as integral portions of a single sheet of glass during fabrication.

A cross-sectional side view of display cover layer 20 in an illustrative arrangement in which layer 20 has different laterally adjacent sections formed from different materials is shown in FIG. 3. In general, layer 20 may be formed from any rigid transparent materials such as glass, glass-ceramic, transparent ceramic, or crystalline material. In an illustrative configuration, which may sometimes be described as an example, layer 20 is formed from glass. In the example of FIG. 3, portions 20A are formed from a first material (e.g., a layer of a first glass material with a first modulus of elasticity) and portion 20B is formed from a second material (e.g., a layer of a second glass material with a second modulus of elasticity that is lower than the first modulus of elasticity). Portions 20A of FIG. 2 have a rectangular plate shape to cover underlying rectangular portions of pixel array 22. Portion 20B has a narrow strip shape (with an illustrative width of 1-50 mm orthogonal to bend axis B) that overlaps and extends along bend axis B. Portions 20A and 20B may be joined to each other side-by-side along interfaces 23.

In a first illustrative embodiment, portions 20A and 20B are fused together along interfaces 23 under heat and pressure or are fused by application of laser light. If desired interfaces 23 may be angled (e.g., so that the joined edges of portions 20A and 20B have complementary wedge shapes, as shown by tapered profiles TP). Meltable glass frit may, if desired, be used at interfaces 23 to help join portions 20A and 20B together.

In a second illustrative embodiment, portions 20A and 20B are formed together during the process of rolling layer 20 (e.g., during the glass melt phase). With this approach, molten glass for portions 20A and molten glass for portion 20B are dispensed into a set of rollers. As the molten glass passes through the rollers, a sheet of solidified glass is formed in which portion 20B is integrally formed between portions 20A.

In a third illustrative embodiment, portions 20A and 20B are formed together using a fusion draw technique in which flowing glass is formed into a sheet with bands of different materials for portions 20A and 20B, respectively.

In a fourth illustrative embodiment, glass for each of portions 20A and 20B is floated onto a layer of molten tin before being cooled to form a glass sheet containing portions 20A and 20B.

In a fifth illustrative embodiment, the glass material of portions 20A is treated differently than the glass of portion 20B, thereby transforming the material properties of portions 20A without changing the properties of portion 20B. As an example, portions 20A may be heated in a mold (e.g., for 5-45 minutes) to an elevated temperature (e.g., 400-500° C. or other suitable elevated temperature) to nucleate ceramic crystals in portions 20A without elevating the temperature of portion 20B and therefore without nucleating ceramic crystals in portion 20B. Following this nucleation step, the glass of portions 20A and 20B may be heated (e.g., for several hours) to an elevated growth temperature (e.g., 500-600° C.). This causes portions 20A to transform at least partly into a glass-ceramic material (glass with polycrystalline portions, which may be characterized by a larger modulus of elasticity than untransformed glass) whereas the glass of portion 20B remains amorphous.

These illustrative arrangements and/or other arrangements may be used to create different materials with different properties in portions 20A and 20B, so that portions 20A can exhibit satisfactory resistance to sharp damage whereas portion 20B can exhibit satisfactory flexibility when device 10 is folded.

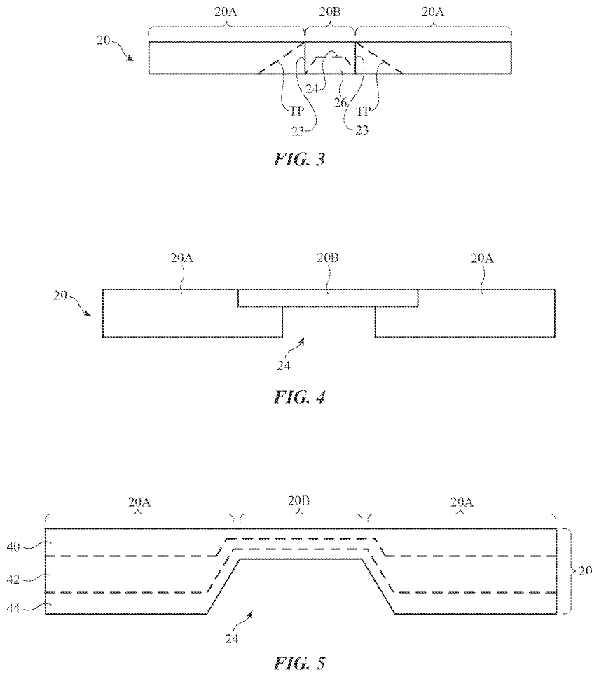

To promote flexibility in portion 20B, some or all of layer 20 may be absent in a strip that runs under strip-shaped portion 20B and extends along bend axis B (FIG. 2), as shown by notch (removed area) 24 of FIG. 3. This recess in layer 20 may be filled with index-matched polymer 26 or other clear flexible material, so that images on pixel array 22 are not optically distorted when a viewer views pixel array 22 through layer 20. Etching or other material removal techniques may be used to remove notch 24 after layer 20 has been formed or, if desired, notch 24 may be formed using an arrangement of the type shown in FIG. 4 in which a thinner glass layer for forming portion 20B is fused to matching notches in thicker glass layers that form portions 20B. Portion 20B may be formed, as an example, from a glass with a lower modulus of elasticity than the glass of portions 20A.

In configurations in which layer 20 is locally thinned in portion 20B, the thickness of portions 20A may be 50-350 microns, 100-300 microns, 150-250 microns, at least 100 microns, at least 150 microns, at least 160 microns, at least 200 microns, less than 300 microns, or other suitable thickness, whereas the thickness of portion 20B may be 40 microns, at least 20 microns, at least 30 microns, less than 80 microns, less than 70 microns, 20-80 microns, less than 90 microns, less than 100 microns, less than 125 microns, less than 150 microns, or other suitable thickness.

If desired, layer 20 may be chemically strengthened (e.g., using an ion exchange process to place surface portions of layer 20 in compression relative to core portions of layer 20). Portions 20A and 20B may be chemically strengthened prior to joining these portions to form layer 20 or after joining these portions to form layer 20.

FIG. 5 is a cross-sectional side view of layer 20 in an illustrative configuration in which layer 20 has been chemically strengthened. Chemical strengthening may be used to create compressive stress in the surfaces of layer 20 to help improve resistance to scratches, sharp damage, cracks, and other surface damage. With chemical strengthening, the exposed surface of layer 20 may be placed in compressive stress using an ion-exchange process. During the ion-exchange process, smaller ions in the glass may be replaced with larger ions. For example, sodium in the glass at the exposed surfaces of layer 32 may be replaced by potassium or lithium in the glass at the exposed surfaces of layer 32 may be replaced by sodium. This exchange creates compressive stress within the treated surface layers of layer 20, while the innermost core of layer 20 is placed into tension.

As shown in FIG. 5, chemical strengthening may place outer portions 40 and 44 under compressive stress, while placing inner (core) portion 42 is under tensile stress. Layer 20 may be exposed to a uniform ion exchange bath or different portions of layer 20 may be treated differently. If desired, portions 20A may be selectively dipped in an ion exchange bath without exposing portion 20B to the bath, portions 20A and 20B may be formed from glasses that respond differently to the same ion exchange bath, thin-film masking layers (e.g., silicon oxide or silicon nitride masks which may be removed by etching) may be used to selectively mask some areas of layer 20 while exposing other areas of layer 20 to an ion exchange bath, and/or spray-coating ion exchange techniques may be used in chemically strengthening layer 20 (e.g., a desired area of layer 20 may be spray coated with selected ion-exchange material (e.g., Na and/or K salts) followed by heating in a furnace to initiate ion exchange.

Using one or more of these illustrative ion exchange techniques, portions 20A and 20B may be provided with desired stress profiles. During use in device 10, it is desirable for portions 20A to exhibit high durability to prevent sharp damage. Portions 20A may be rigid and need not flex. To enhance resistance to sharp damage, it may be desirable to provide these regions with a relatively deep compressive stress layer (e.g., layers 40 and 44 may be relatively deep). In portion 20B, however, it may be desirable to further enhance the peak compressive stress level that is obtained from ion exchange. The magnitude of the compressive stress produced in portion 20B may, as an example, be larger than the magnitude of the compressive stress produced in portion 20A to help ensure that portion 20B is not damaged during bending. Layers 40 and 44 may be shallower in portion 20B to help achieve this desired larger compressive stress magnitude.

If desired, portions 20A and portions 20B may be masked during ion exchange. As an example, portion 20B may be masked while a deep ion exchange is performed (for portions 20A). The mask over portion 20B may then be removed and another mask may be formed over portions 20A. While portions 20A are masked, a short ion exchange that creates a high peak compressive stress level may then be performed. Using this approach, portions 20A may be provided with a deep compressive stress profile and portion 20B may be provided with a shallower (but more intense) compressive stress profile.

Another way to provide layer 20 with different compressive surface stress profiles in different areas involves using different types of glasses to form different portions of layer 20. As an example, portions 20A may be formed from lithium alumino silicate glass, whereas portion 20B may be formed from alumino silicate glass. During a first ion exchange process, layer 20 may be placed in a Na ion exchange bath (e.g., a sodium nitrate bath). This causes Na to exchange deeply with Li in portions 20A, but not portion 20B, creating deep compressive stress layers in portions 20A. In a subsequent second ion exchange process, layer 20 may be placed in a K ion exchange bath (e.g., a potassium nitrate bath). During the second ion exchange process, K is exchanged for Na in portions 20A and 20B, creating a shallow compressive stress layer. This shallow layer overlaps the deep compressive stress layer in portion 20A and forms a shallow compressive stress layer in portion 20B that is larger in magnitude than the compressive stress of the deeper compressive stress layer in portion 20A. If desired, a single ion exchange bath may be applied that contains both Na and K ions. For example, an ion exchange bath may contain 80% sodium nitrate and 20% potassium nitrate. In this type of bath, the Na ions will substitute deeply for the Li in portions 20A to create a deep compressive stress profile in portions 20A, whereas the K ions will substitute for Na and will form a shallower compressive stress layer across both portions 20A and 20B. As a result, layers 40 and 44 will be thicker (deeper) in portions 20A than in portion 20B, as shown in FIG. 5. Notch 24 may be formed by etching layer 20 prior to ion exchange or by fusing a thin piece of glass for portion 20B to thicker pieces of glass for portions 20A as shown in FIG. 4 prior to ion exchange. Notches 24 of FIGS. 4 and 5 may, if desired, be filled with flexible index-matched polymer 26 as shown in FIG. 3 before mounting cover layer 20 over pixel array 22.

To help protect the privacy of users, any personal user information that is gathered by electronic devices may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A foldable device configured to fold about a bend axis, comprising:
a display that overlaps the bend axis; and
a display cover layer that overlaps the bend axis and that is configured to bend about the bend axis, wherein the display cover layer comprises first, second, and third portions, wherein the first and third portions are rectangular layers that overlap the display without overlapping the bend axis, wherein the second portion is between the first and third portions and has a strip shape that extends along the bend axis, wherein the first and third portions are formed from a first material, and wherein the second portion is formed from a second material that is different than the first material.

2. The foldable device defined in claim 1 wherein the first material is a first glass material, wherein the second material is a second glass material, and wherein the first glass material has a larger modulus of elasticity than the second glass material.

3. The foldable device defined in claim 2 wherein the second portion is thinner than the first and third portions.

4. The foldable device defined in claim 3 wherein the second portion has a compressive stress layer characterized by a first depth and wherein the first and third portions have compressive stress layers that are characterized by a second depth that is greater than the first depth.

5. The foldable device defined in claim 4 wherein the first glass material is lithium alumino silicate glass.

6. The foldable device defined in claim 5 wherein the second glass material is alumino silicate glass.

7. The foldable device defined in claim 6 wherein the second portion comprises a strip of glass that is fused to the first and third portions.

8. The foldable device defined in claim 6 wherein the second portion comprises an etched notch.

9. The foldable device defined in claim 1 wherein the first and third portions are characterized by a compressive stress layer of a first depth and wherein the second portion is characterized by a compressive stress layer of a second depth that is less than the first depth.

10. The foldable device defined in claim 1 wherein the first material is glass ceramic and wherein the second material is glass.

11. The foldable device defined in claim 1 wherein the second portion is thinner than the first and third portions.

12. The foldable device defined in claim 1 wherein the first and third portions have thicknesses of at least 150 microns and wherein the second portion has a thickness of less than 125 microns.

13. A foldable device configured to fold about a bend axis, comprising:
a display that overlaps the bend axis; and
a cover glass layer that overlaps display, wherein the cover glass layer comprises first, second, and third layers of glass that are joined together side-by-side, wherein the second layer of glass comprises a strip of bendable glass that extends along the bend axis and that is between the first and third layers of glass, and wherein the second layer of glass is formed from a different glass material than the first and third layers of glass.

14. The foldable device defined in claim 13 wherein the first and third layers of glass have a first modulus of elasticity and wherein the second layer of glass has a second modulus of elasticity that is less than the first modulus of elasticity.

15. The foldable device defined in claim 14 wherein the second layer of glass is configured to bend about the bend axis and wherein the second layer of glass has a thickness of less than 100 microns.

16. The foldable device defined in claim 15 wherein the second layer of glass has a width orthogonal to the bend axis of 1-50 mm.

17. The foldable device defined in claim 16 wherein the first and third layers of glass are lithium alumino silicate glass.

18. The foldable device defined in claim 17 wherein the second layer of glass is alumino silicate glass.

19. The foldable device defined in claim 18 wherein the cover glass layer is chemically strengthened and has a compressive stress layer that is deeper in the first and third layers of glass than in the second layer of glass.

20. A foldable device configured to fold about a bend axis, comprising:
a display that overlaps the bend axis; and
a cover glass layer that overlaps display, wherein the cover glass layer comprises first, second, and third portions that extend laterally across the display and that are formed respectively from first, second, and third glasses, wherein the second portion is formed between the first and third portions, extends along the bend axis, and is configured to bend about the bend axis when the first and second portions are folded towards each other, wherein the first and third glasses comprise lithium aluminosilicate glass, and wherein the second glass comprises aluminosilicate glass.
